(19) United States
(12) Patent Application Publication
(10) Pub. No.: US 2010/0057506 A1
(43) Pub. Date: Mar. 4, 2010

(54) CONVERSION VALUE REPORTING USING CONVERSION VALUE PIXEL

(75) Inventor: Johannes Cornelious Schouten, New York, NY (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/200,350

(22) Filed: Aug. 28, 2008

(51) Int. Cl. G06Q 10/00; G06F 15/16

(52) U.S. Cl. 705/7

(57) ABSTRACT

A first web page at a first server includes a clickable advertisement. The reporting pixel is associated with a unique identification. The reporting pixel is further associated with the advertisement or with a line item or campaign that is associated with the advertisement. When a user clicks on the advertisement, the user's client browser is redirected to a second web page corresponding to the advertisement at a second server. The redirect includes context information associated with the advertisement. The second web page eventually leads the user to a conversion. The second server obtains the revenue generated from the conversion and reports the revenue to the first server. The revenue is identified by the pixel identification associated with the reporting pixel and the context information associated with the advertisement. The first server collects and aggregates the revenue for the advertisement, or line item or campaign to which the advertisement is associated.

### TECHNICAL FILED

The present disclosure generally relates to collecting advertising information and particularly revenue generated by an advertisement.

### BACKGROUND

Advertising on the Internet has grown into a multi-billion-dollar business. In a common scenario, an advertising service provider provides the Internet advertising medium. The advertising medium may take various forms, such as web pages, live feeds, electronic messages, etc. An advertiser, also referred to as a sponsor, may purchase a certain amount of advertising space from the advertising service provider to place its advertisements in the advertising medium provided by the advertising service provider. For example, it is common to find ad banners and/or other forms of advertisements (e.g., clickable images or texts, etc.) included in web pages along with the primary content of the web pages.

FIG. 1 (prior art) illustrates a portion of a sample web page 100 that contains an advertisement 110 that is located near the web page's lower right corner. In this example, the advertising service provider is Yahoo, Inc.; the advertising medium is the web page 100; and the sponsor is Netflix, Inc. Netflix Inc. has purchased a certain amount of space in the web page 100 from Yahoo, Inc. to place the advertisement 110 in the web page 100. A user viewing the web page 100 may click on the advertisement 110 and be directed to Netflix Inc.'s website.

For various business reasons, it is often desirable and sometimes necessary to collect information concerning the advertisements placed on the Internet advertising medium. For example, both the advertising service provider and the sponsor may wish to know how many times a web page that includes a particular advertisement has been viewed by users, how many times a particular advertisement has been clicked by users, how much revenue a particular advertisement has generated, etc. Although there are various existing methods that collect some statistical information concerning advertisements placed on web pages, most of these methods collect information in real time.

### SUMMARY

Broadly speaking, the present disclosure generally relates to collecting advertising information.

According to various embodiments, a reporting pixel is associated with a specific line item, campaign, or advertisement. The reporting pixel is a one-by-one pixel and is associated with a unique identification (ID). When a user clicks on the advertisement, the context information associated with the advertisement is sent to a server associated with a sponsor of the advertisement (i.e., the sponsor server). The context information may include, but not limited to, the identification of the advertisement, the date and time the advertisement is served or clicked by the user, and/or the publisher of the advertisement.

Subsequently, the sponsor server reports additional information concerning the advertisement to a server associated with an advertising service provider (i.e., the advertising server). According to one embodiment, the additional information includes the revenue generated from the conversion as a result of the user clicking on the advertisement. The reporting is identified using the pixel ID associated with the reporting pixel, which is associated with the line item, campaign, or advertisement, and the context information associated with the advertisement.

The advertising server collects and aggregates reports from the sponsor server over a period of time and generates a comprehensive report for the advertisement.

These and other features, aspects, and advantages of the disclosure will be described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 (prior art) illustrates a portion of a sample web page that contains an advertisement.

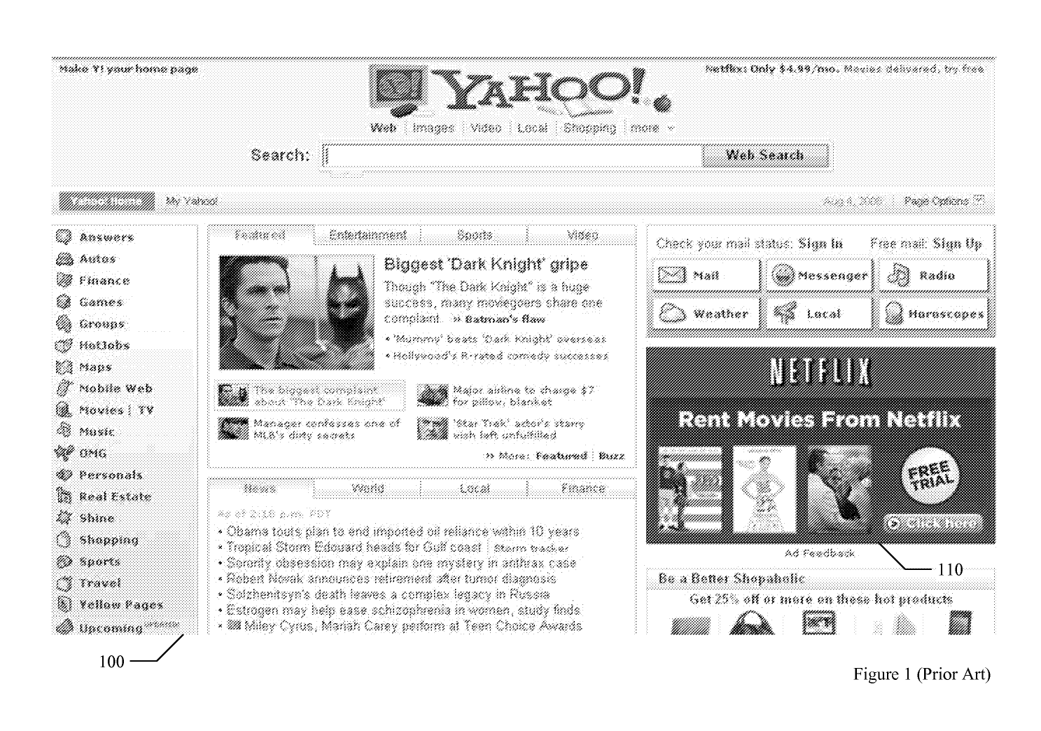

FIG. 2 illustrates the communications between an advertising server and a sponsor server according to one embodiment of the present disclosure.

FIG. 3 illustrates a method of collecting revenue information using a conversion value pixel according to one embodiment of the present disclosure.

FIG. 4 illustrates a general computer system suitable for implementing embodiments of the present disclosure.

### DETAILED DESCRIPTION

The present disclosure will now be described in detail with reference to a few preferred embodiments thereof as illustrated in the accompanying drawings. In the following description, numerous specific details are set forth in order to provide a thorough understanding of the present disclosure. It will be apparent, however, to one skilled in the art, that the present disclosure may be practiced without some or all of these specific details. In other instances, well known process steps and/or structures have not been described in detail in order to not unnecessarily obscure the present disclosure. In addition, while the disclosure will be described in conjunction with the particular embodiments, it will be understood that this description is not intended to limit the disclosure to the described embodiments. To the contrary, the description is intended to cover alternatives, modifications, and equivalents as may be included within the spirit and scope of the disclosure as defined by the appended claims.

For Internet advertising, it is often desirable and sometimes necessary to collect statistical information concerning the advertisements placed in web pages. One way to determine the number of times a particular advertisement has been viewed during a certain period of time is to embed one or more reporting pixels in the advertisement.

In the context of Internet advertising, a reporting pixel is usually a one-by-one pixel that may be placed anywhere, but preferably at an inconspicuous or unobtrusive location, in the advertisement. A macro, which may be written in a script language, is associated with the reporting pixel. Each time the advertisement is served in response to a client request, the macro associated with the reporting pixel initiates a callback to a server associated with the advertising service provider (i.e., the advertising server), indicating that the advertisement has been viewed and optionally reporting additional information such as the identification of the reporting pixel, the context information of the advertisement (e.g., the identification of the advertisement, the date and time the advertisement is served, and/or the publisher of the advertisement), etc. The advertising server collects and aggregates information from multiple callbacks to determine the number of times the advertisement has been viewed.

Information collected using the above method is real-time information, because as soon as the advertisement is served (i.e., loaded in a client browser), the macro associated with the reporting pixel initiates the callback to the advertising server. There is no indication of what subsequent action(s), if any, a user actually takes concerning the advertisement placed in the web page. For example, the user may ignore the advertisement completely, may click on the advertisement, or may eventually complete a purchase from the sponsor of the advertisement, etc.

However, to the sponsor of the advertisement, it is often desirable to obtain more detailed information concerning the user actions. From a business' point of view, not all users are equally valuable to a sponsor. Generally speaking, users who purchase a product or service as a result of viewing an advertisement are more valuable to the sponsor than users who ignore the advertisement. Users who purchase multiple products from the same sponsor (i.e., repeat customers) are more valuable than users who make one time purchases. In addition, the sponsor often wishes to know whether an advertisement has generated sufficient revenue to make the advertisement cost-effective since the sponsor has to pay the advertising service provider for the space of the advertisement.

Real-time reporting is inadequate in these situations as the information needed often becomes available only some time after the advertisement is served. For example, a user may eventually purchase a product as a result of viewing and clicking on the advertisement, but the actual transaction may be completed hours, even days after the advertisement had initially been served.

According to various embodiments, to collect information that only becomes available subsequent to serving an advertisement, instead of initiating a callback to the advertising server when the advertisement is first served, when a user actually clicks on the advertisement, the context information associated with the advertisement is sent to a server associated with the sponsor of the advertisement (i.e., the sponsor server) as the user is redirected to the sponsor's website.

The sponsor server saves the context information associated with the advertisement that has been clicked by the user. Subsequently, after the additional information has become available, the sponsor server reports the information to the advertising server along with the pixel ID associated with the reporting pixel and the context information. For example, once a purchase has been completed, the sponsor server reports the revenue amount (i.e., the purchase price) to the advertising server with the pixel ID and the context information. The reporting is in non-real time, as the information reported becomes available after the advertisement is served.

The advertising server identifies the information received from the sponsor server using the pixel ID and the context information. The information (e.g., the revenue) is collected and aggregated to generate a report for the particular advertisement, line item, or campaign.

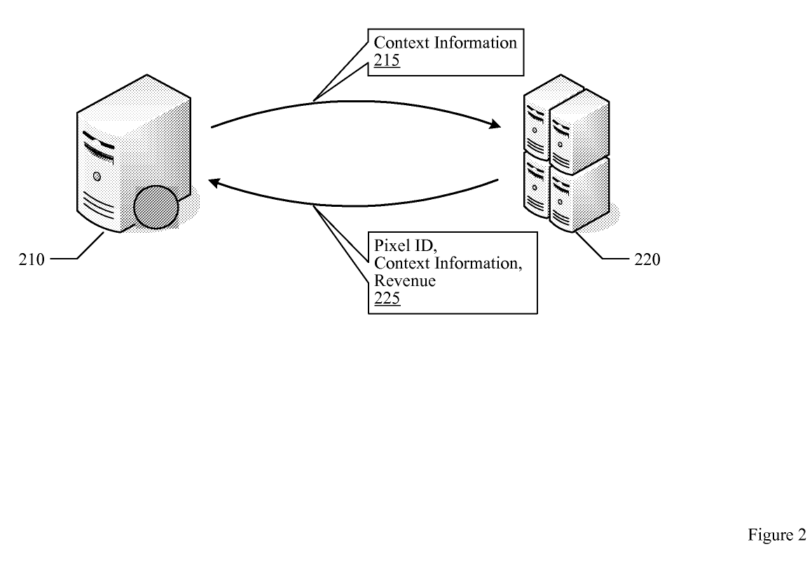

FIG. 2 illustrates the communications between an advertising server 210 and a sponsor server 220 according to one embodiment of the present disclosure. The advertising server 210 is associated with the advertising service provider and hosts the web pages that contain the advertisements. The sponsor server 220 is associated with the sponsor of an advertisement. A web page may contain one or more clickable advertisements. An advertisement may be associated with one or more reporting pixels. Each reporting pixel is associated with a unique identification, and the pixel identification is known to both the advertising server 210 and the sponsor server 220.

When a user clicks on an advertisement contained in a web page that is served by the advertising server 210, the user's client browser is redirected to a corresponding sponsor's web page, which is hosted on the sponsor server 220. The context information associated with the advertisement 215 is appended at the end of the URL (Universal Resource Locator) identifying the sponsor's web page and sent to the sponsor server 220.

In particular implementations, redirection generally refers to transmitting a message from a server to a client application, for example, that causes the client application to access another server or resource without intervention or action by the end-user. Redirection can be accomplished in a number of different ways. For example, in connection with HTTP, redirection messages can be implemented using refresh meta tags, such as

<html>
<header>
<meta http-equiv=“refresh” content=“0;
url=http://www.yahoo.com”>
</header>
</html>

In addition, redirection messages can be implemented using HTTP refresh headers. For example:

HTTP/1.1 200 ok
Content-type: text/html
Refresh: 0; url=http://www.yahoo.com/
Content-length: 78
Follow <a href=“http://www.yahoo.com/”>link</a>.

Redirection can also be accomplished by transmitting an HTML page including JavaScript code operative to accomplish redirection. Other suitable redirection methods can be used for other protocol environments

Subsequently, after a conversion or a transaction associated with the advertisement contained in the web page has been completed, the sponsor server 220 reports the additional information 225, such as the revenue generated by the conversion or transaction, back to the advertising server 210. The additional information 225 is identified using the pixel ID and the context information so that the advertising server 210 is able to determine with which advertisement the additional information is associated.

In the embodiment illustrated in FIG. 2, the same server 210 both hosts the web pages and collects the reporting from the sponsor server 220. In an alternative embodiment, two different servers may be associated with the advertising service provider. One server hosts the web pages, while another server collects and aggregates the reporting from the sponsor server 220. In this case, the sponsor server 220 sends the reports to the server that is responsible for collecting the reporting.

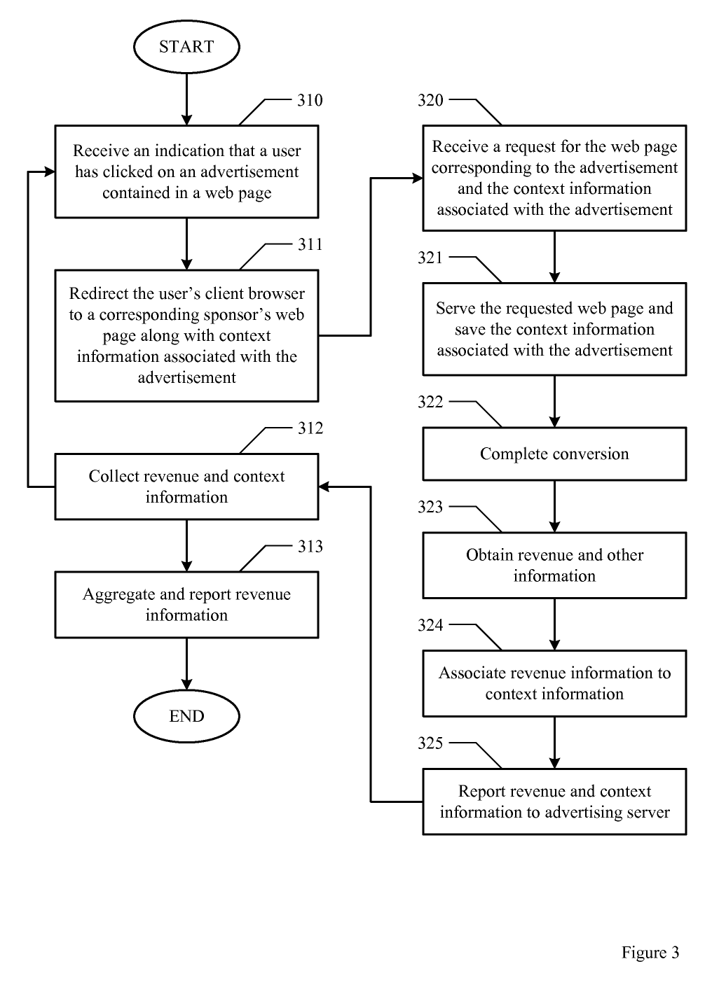

FIG. 3 illustrates a method of collecting revenue information using a conversion value reporting pixel according to one embodiment of the present disclosure. On the left are functionalities performed by a server associated with an advertising service provider (hereinafter referred to as the “advertising server”). On the right are functionalities performed by a server associated with the sponsor (hereinafter referred to as the “sponsor server”). FIG. 3 is described in connection with the advertising server 210 and the sponsor server 220 shown in FIG. 2.

Suppose a sponsor has placed a clickable advertisement in a web page (hereinafter referred to as “the first web page”), which is hosted by the advertising server 210. The advertisement may be associated with a line item or a campaign. When a user clicks on the advertisement, the user's client browser is redirected to a corresponding sponsor's web page (hereinafter referred to as “the second web page”), which is hosted by the sponsor server 220.

A reporting pixel has been associated with the advertisement or with the line item or campaign that is associated with the advertisement. A unique identification has been assigned to the reporting pixel (pixel ID). Both the advertising server 210 and the sponsor server 220 are aware of the pixel ID associated with the reporting pixel.

A user has requested the first web page from the advertising server 210. The advertising server 210 serves the first web page in response to the user request, and the first web page is loaded in the user's client browser. If, after viewing the first web page, the user is not interested in the advertisement placed therein, the user typically ignores the advertisement and moves on to other tasks, such as viewing another web page. In this case, there is no additional information to be collected or report in connection with the advertisement.

On the other hand, if, after viewing the first web page, the user is interested in the advertisement placed therein, the user may click on the advertisement to obtain more information about the product or service being advertised in the advertisement. The clicking of the advertisement by the user causes an event notification to be sent to the advertising server 210.

The advertising server 210, upon receiving the indication that the user has clicked on the advertisement contained in the first web page (step 310), redirects the user's client browser to the corresponding second web page hosted by the sponsor server 220 along with the context information associated with the advertisement clicked by the user, which will be used subsequently to correlate a report from the sponsor server 220 with the advertisement or with the line item or campaign that is associated with the advertisement. According to one embodiment, the redirect may be achieved by sending the URL of the second web page to the client browser. In addition, the context information is added to the end of the URL as an argument. For example, a redirect URL with the context argument may take the form “http://www.sponsorserver.com/webpage.html?ymid=${CONTEXT}”. In this example, “www. sponsorserver.com/webpage. html” is the URL for the second web page; “ymid” is the argument for the context information; and “$ {CONTEXT }” is a macro that, when expanded, represents the context information.

The sponsor server 220, upon receiving a request for the redirect URL from the user's client browser (step 320), serves the second web page to the user's client browser as well as captures and saves the context information from the URL (step 321). Again, the context information is identified by the argument “ymid”, of which the sponsor server is aware.

Suppose the user eventually decides to purchase the product or service described in the second web page. The user goes through a series of steps to complete the transaction, such as adding the product or service in his or her shopping cart, entering contact, payment, and shipping information, etc. In response, the sponsor server 220 confirms the user's payment method, and sends confirmation emails to the user. Some time later, the transaction is completed (step 322). The sponsor server 220 obtains the revenue information based on the completed transaction (step 323), which may be the purchase price of the product or service. Optionally, the sponsor server 220 may obtain other information concerning this particular transaction, such as information concerning the user making the purchase, the time the transaction is completed, etc.

The sponsor server associates the revenue information with the context information associated with the advertisement or with the line item or campaign that is associated with the advertisement (step 324). The sponsor server 220 then reports the revenue information to the advertising server 210 (step 325). The pixel ID associated with the reporting pixel and the context information sent by the advertising server 210 with the redirect URL are used to identify the advertisement or the associated line item or campaign with which the revenue is associated.

The advertising server 210 typically hosts many web pages and each web page may include multiple advertisements. Earlier at step 311, when a user clicks on a specific advertisement, the context information is generated for that advertisement at the advertising server 210 and sent to the sponsor server 220 when the client browser is redirected to the sponsor server 220. At step 321, the sponsor server 220 saves the context information for the advertisement. Now at step 325, the context information for the advertisement is sent back to the advertising server 210 with the revenue information by the sponsor server 220. The advertising server 210 may then use the context information to identify the specific advertisement or the associated line item or campaign that eventually led to the transaction from which the revenue has been generated.

The reporting may also use the HTTP protocol. For example, the reporting call may take the form “http://www.advertingserver.com/pixel?id=PIXEL_ID&context=CONT EXT_INFO&revenue=$.$$”. In this example, “http://www.advertingserver.com/pixel” is the URL associated with the advertising server 210 used for revenue reporting. The call has three arguments: “id” is the pixel ID associated with the pixel embedded in the first web page; “context” is the context information sent to the sponsor server by the advertising server with the redirect URL; and “revenue” is the amount of revenue generated from the transaction. Optionally, additional information concerning the transaction may be similarly reported using additional arguments.

The HTTP call may be sent in various ways. First, it may be sent using cURL, which is a command line tool for transferring files with URL syntax. If cURL is available on the sponsor server 220, then the above HTTP call may be made directly from command line. For example:

% curl
http://www.advertingserver.com/pixel?id=1&context=
AAAAAAAA&revenue=12.34

Alternatively or if cURL is not available on the sponsor server 220, then the above HTTP call may be included in a HTML document. For example:

<html>
<body>
<script src=”
http://www.advertingserver.com/pixel?id=1&context=
AAAAAAAA&revenue=12.34”></script>
</body>
</html>

The HTML document may be loaded in a web browser for the script to be executed.

The advertising server 210, upon receiving the reporting HTTP call from the sponsor server 220, collects the revenue amount, which is identified by the “revenue” argument (step 312). The advertising server 210 determines with which advertisement or which associated line item or campaign the revenue amount is associated using the pixel identification and the context information sent from the sponsor server 220 in the HTTP call.

Steps 310-312 and 320-325 are repeated each time a user clicks on the advertisement and completes a conversion. Over a period of time, the advertising server 210 aggregates the revenue information received from the sponsor server 220 and reports the total amount of revenue the advertisement or the line item or campaign that is associated with the advertisement has generated during that period. Of course, the method may be applied to multiple advertisements placed in different web pages.

The method shown in FIG. 3 uses a pixel ID to identify an advertisement, line item, or campaign for which the revenue information is collected. However, pixel ID is only one method of identifying an advertisement, line item, or campaign. Any identification system may be used to identify an advertisement, line item, or campaign, as long as both the advertising server and the sponsor server agree on the system.

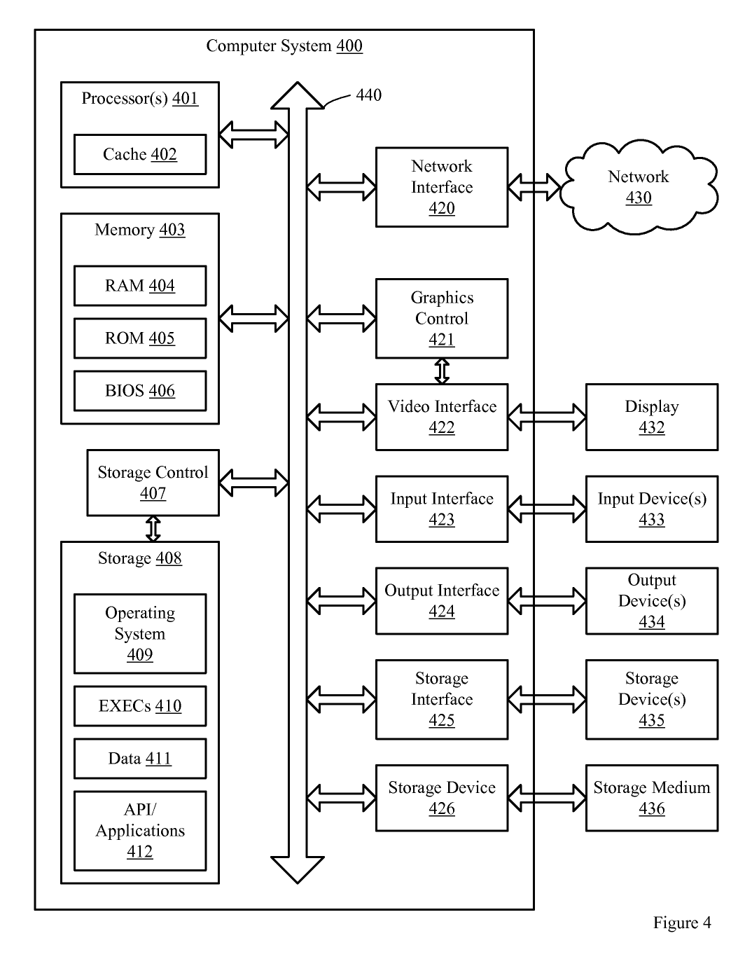

The method illustrated in FIG. 3 may be implemented as computer software using computer-readable instructions and stored in computer-readable medium. The software instructions may be executed on various types of computers. For example, FIG. 4 illustrates a computer system 400 suitable for implementing embodiments of the present disclosure. The components shown in FIG. 4 for computer system 400 are exemplary in nature and are not intended to suggest any limitation as to the scope of use or functionality of the API. Neither should the configuration of components be interpreted as having any dependency or requirement relating to any one or combination of components illustrated in the exemplary embodiment of a computer system. The computer system 400 may have many physical forms including an integrated circuit, a printed circuit board, a small handheld device (such as a mobile telephone or PDA), a personal computer or a super computer.

Computer system 400 includes a display 432, one or more input devices 433 (e.g., keypad, keyboard, mouse, stylus, etc.), one or more output devices 434 (e.g., speaker), one or more storage devices 435, various types of storage medium 436.

The system bus 440 link a wide variety of subsystems. As understood by those skilled in the art, a “bus” refers to a plurality of digital signal lines serving a common function. The system bus 440 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 401 (also referred to as central processing units, or CPUs) optionally contain a cache memory unit 402 for temporary local storage of instructions, data, or computer addresses. Processor(s) 401 are coupled to storage devices including memory 403. Memory 403 includes random access memory (RAM) 404 and read-only memory (ROM) 405. As is well known in the art, ROM 405 acts to transfer data and instructions uni-directionally to the processor(s) 401, and RAM 404 is used typically to transfer data and instructions in a bi-directional manner. Both of these types of memories may include any suitable of the computer-readable media described below. A fixed storage 408 is also coupled bi-directionally to the processor(s) 401, optionally via a storage control unit 407. It provides additional data storage capacity and may also include any of the computer-readable media described below. Storage 408 may be used to store operating system 409, EXECs 410, application programs 412, data 411 and the like and is typically a secondary storage medium (such as a hard disk) that is slower than primary storage. It will be appreciated that the information retained within storage 408, may, in appropriate cases, be incorporated in standard fashion as virtual memory in memory 403.

Processor(s) 401 is also coupled to a variety of interfaces such as graphics control 421, video interface 422, input interface 423, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 401 may be coupled to another computer or telecommunications network 430 using network interface 420. With such a network interface 420, it is contemplated that the CPU 401 might receive information from the network 430, or might output information to the network in the course of performing the above-described method steps. Furthermore, method embodiments of the present disclosure may execute solely upon CPU 401 or may execute over a network 430 such as the Internet in conjunction with a remote CPU 401 that shares a portion of the processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
serving a first web page to a client, wherein the first web page includes an advertisement selected from a plurality of advertisements;
receiving, at a first server, from a client a request generated by activation of the advertisement placed in the first web page;
generating context information for the advertisement;
transmitting a redirection message including the context information to the client, wherein the redirection message is operative to cause the client to access a second server to transmit a request for a second web page, the request for the second page including the context information; and
receiving a report including the context information and information indicating revenue associated with a conversion event.

2. A method as recited in claim 1, further comprising:
correlating, based on the received context information, revenue associated with conversion events with respective advertisements of the plurality of advertisements.

3. A method as recited in claim 2, further comprising:
transmitting a revenue report comprising at least a portion of the correlated revenue data.

4. A method as recited in claim 1, further comprising:
associating a reporting pixel with the advertisement, and both the first server and the second server are aware of the pixel identification.

5. A method as recited in claim 4, wherein when reporting the information indicating revenue associated with the conversion is identified with the pixel identification associated with the reporting pixel and the context information generated for the advertisement.

6. A method as recited in claim 1, wherein the redirection message is a URL corresponding to the second web page, and the context information is attached to an end of the URL as an argument.

7. A method as recited in claim 6, wherein the pixel identification, the context information, and the revenue are attached to an end of a URL corresponding to the HTTP call as three arguments respectively.

8. A method, comprising:
receiving from a client a request for a first web page, wherein the web page contains a clickable advertisement;
receiving from a client a click on the advertisement;
generating context information for the advertisement;
redirecting the client to a second web page corresponding to the advertisement hosted on a sponsor server with the context information;
receiving from the sponsor server a revenue generated by the advertisement; and
aggregating and reporting revenue information for the advertisement.

9. A method as recited in claim 8, wherein the reporting pixel is associated with a unique identification that is used by the sponsor server to identify the revenue as generated by the advertisement.

10. A method as recited in claim 9, wherein the context information is further used by the sponsor server to identify the revenue as generated by the advertisement.

11. A computer program product comprising a computer-readable medium having a plurality of computer program instructions stored therein, which are operable to cause at least one computing device to:
serve a first web page to a client, wherein the first web page includes an advertisement selected from a plurality of advertisements;
receive, at a first server, from a client a request generated by activation of the advertisement placed in the first web page;
generate context information for the advertisement;
transmit a redirection message including the context information to the client, wherein the redirection message is operative to cause the client to access a second server to transmit a request for a second web page, the request for the second page including the context information; and
receive a report including the context information and information indicating revenue associated with a conversion event.

12. A computer program product as recited in claim 11, wherein the plurality of computer program instructions are further operable to cause the at least one computing device to:
correlating, based on the received context information, revenue associated with conversion events with respective advertisements of the plurality of advertisements.

13. A computer program product as recited in claim 12, wherein the plurality of computer program instructions are further operable to cause the at least one computing device to:
transmit a revenue report comprising at least a portion of the correlated revenue data.

14. A computer program product as recited in claim 11, wherein the plurality of computer program instructions are further operable to cause the at least one computing device to:
associate a reporting pixel with the advertisement, and both the first server and the second server are aware of the pixel identification.

15. A computer program product as recited in claim 14, wherein when reporting the information indicating revenue associated with the conversion is identified with the pixel identification associated with the reporting pixel and the context information generated for the advertisement.

16. A computer program product as recited in claim 11, wherein the redirection message is a URL corresponding to the second web page, and the context information is attached to an end of the URL as an argument.

17. A computer program product as recited in claim 16, wherein the pixel identification, the context information, and the revenue are attached to an end of a URL corresponding to the HTTP call as three arguments respectively.
